(19) United States
(12) Patent Application Publication
(10) Pub. No.: US 2011/0197391 A1
(43) Pub. Date: Aug. 18, 2011

(54) AUTOMATIC DOOR CLOSER STRUCTURE

(76) Inventors: Rick YU, Changhua County (TW); Ju-Kuan Yang, Changhua County (TW)

(21) Appl. No.: 12/705,274

(22) Filed: Feb. 12, 2010

(51) Int. Cl. E05F 3/04; E05F 3/00

(52) U.S. Cl. 16/51; 16/49

(57) ABSTRACT

An automatic door closer structure comprises a casing, at least one piston, at least one limiting member, at least one driving member connected with the piston and a shaft. The casing has an outside wall, a chamber, an inside wall and at least one first limiting portion. The piston slidably disposed within the chamber of the casing has an outer wall and a second limiting portion formed on the outer wall. The limiting member has a first end portion and a second end portion both are connected with the first limiting portion of the casing and the second limiting portion of the piston respectively to limit rotation of the piston. The shaft comprises a shaft body pivotally disposed in the casing and an eccentric cam contacts against the driving member.

### FIELD OF THE INVENTION

The present invention is generally relating to a door closer, more particularly to an automatic door closer structure able to prevent rotation of piston.

### BACKGROUND OF THE INVENTION

Door closer is typically used for providing a damping action against a door to generate a buffer effect while closing the door, and a resilient member installed within door closer can store energy during compressed to automatically and slowly pull door back and then restore door-closing state when exterior force is moved away from door. However, the piston disposed within the known door closer to act for transmission may rotate during transverse movement to cause attrition among other internal components and result in operating unsmooth of door closer.

### SUMMARY

A primary object of the present invention is to provide an automatic door closer structure comprising a casing, at least one piston, at least one limiting member, at least one driving member connected with the piston and a shaft. The casing has an outside wall, a chamber, an inside wall and at least one first limiting portion. The piston slidably disposed within the chamber of the casing has an outer wall and a second limiting portion formed on the outer wall. The limiting member has a first end portion and a second end portion, wherein the first and second end portions are connected with the first limiting portion of the casing and the second limiting portion of the piston respectively. The shaft comprises a shaft body and an eccentric cam coupled to the shaft body, wherein the shaft body is pivotally disposed in the casing, the eccentric cam can contact against the driving member. The present invention can limit rotation of the piston by applying engagement among the limiting member, the first limiting portion of the casing and the second limiting portion of the piston, which efficiently reduces attrition among other components inside the door closer and enhances operating smooth of the door closer.

### DESCRIPTION OF THE DRAWINGS

FIG. 1 is a perspective exploded view illustrating an automatic door closer structure in accordance with a preferred embodiment of the present invention.

FIG. 2 is a perspective assembly view illustrating the automatic door closer structure.

FIG. 3 is an assembly longitudinal section view illustrating the automatic door closer structure taken along line A-A of FIG. 2.

FIG. 4 is an assembly transverse section view illustrating the automatic door closer structure taken along line B-B of FIG. 2.

FIG. 5 is a side view of the automatic door closer structure.

FIG. 6 is an assembly section view illustrating the automatic door closer structure taken along line C-C of FIG. 5.

### DETAILED DESCRIPTION OF THE INVENTION

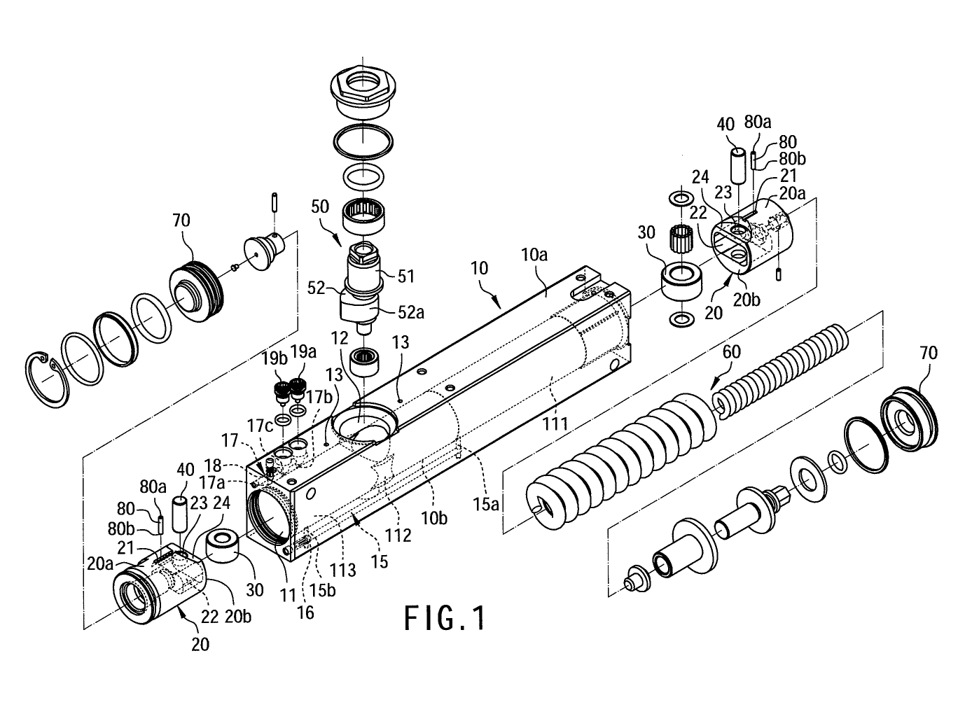

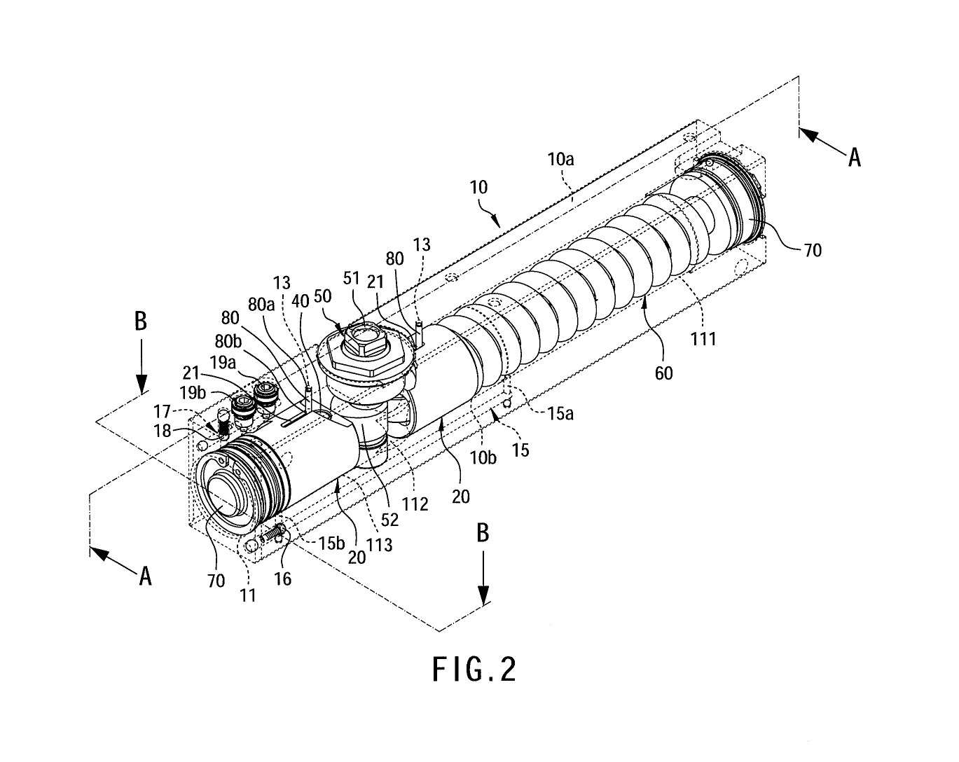

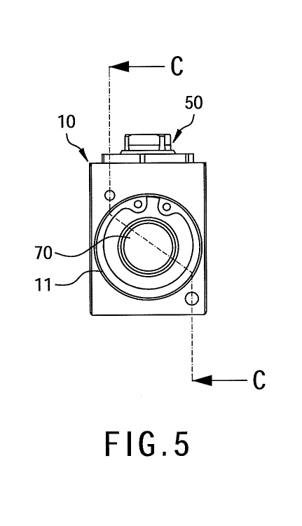

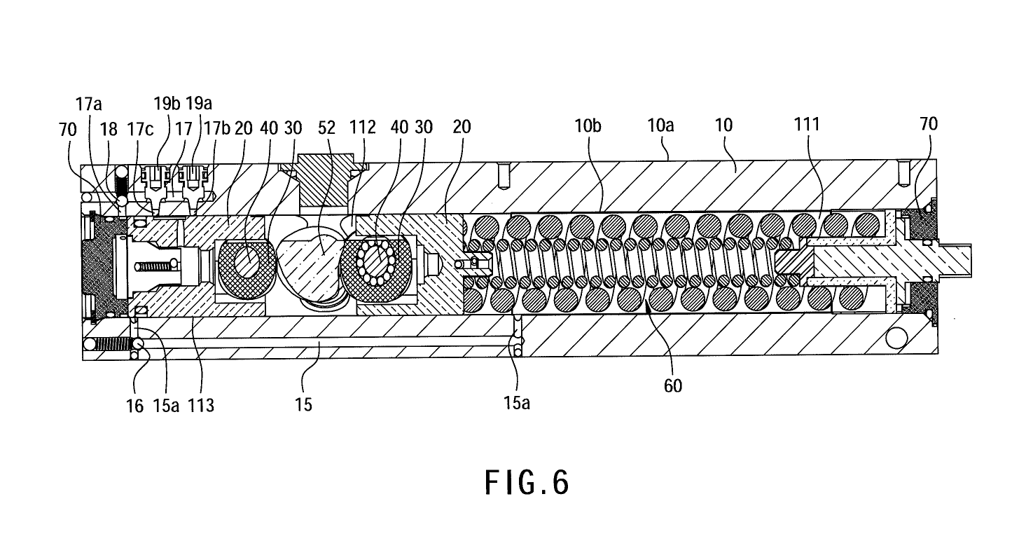

With reference to FIGS. 1 and 2, an automatic door closer structure in accordance with a preferred embodiment of the present invention comprises a casing 10, at least one limiting member 80, at least one piston 20, at least one driving member 30, at least one connecting member 40, a shaft 50, an elastic assembly 60 and a pair of lids 70. The casing 10 has an outside wall 10a, a chamber 11, a shaft hole 12 in communication with the outside wall 10a and the chamber 11, an inside wall 10b and at least one first limiting portion 13 in communication with the outside wall 10a and the inside wall 10b. The chamber 11 is filled with hydraulic oil having a front chamber 111, a rear chamber 113 and a middle chamber 112 in communication with the front chamber 111 and the rear chamber 113. Within this embodiment, the casing 10 has a pair of first limiting portions 13, each of them is a through hole in communication with the outside wall 10a and the inside wall 10b, and preferably formed at two laterals of the shaft hole 12 respectively and has a diameter D. With reference to FIGS. 1, 2 and 3, the automatic door closer structure uses a pair of limiting members 80 and each of them has a first end portion 80a and a second end portion 80b corresponding to the first end portion 80a, wherein the first end portions 80a connect with the first limiting portions 13 respectively and preferably each of them is fixed within the first limiting portion (through hole) 13 of the casing 10. Besides, it may further comprises a leak stopper (not shown in the drawing) disposed at each first limiting portion 13 within this embodiment so as to prevent hydraulic oil inside the chamber 11 from leaking through each first limiting portion 13, wherein steel ball, oil ring or drain-stopping valve can be applied as leak stopper. With reference to FIGS. 1, 2, 5 and 6, inside the casing 10, there are a first oil passage 15 in communication with the front chamber 111 and the rear chamber 113, a first check valve 16 positioned inside the first oil passage 15, a second oil passage 17 in communication with the rear chamber 113 and a second check valve 18 positioned inside the second oil passage 17. The first oil passage 15 has an oil inlet 15a in communication with the front chamber 111 and an oil outlet 15b in communication with the rear chamber 113. The first check valve 16 is disposed adjacent to the oil outlet 15b of the first oil passage 15, the second oil passage 17 has an inlet 17a, a first outlet 17b and a second outlet 17c which are communicated with the rear chamber 113 respectively, the second check valve 18 is disposed adjacent to the inlet 17a of the second oil passage 17. In addition, the casing 10 further has a first needle valve 19a disposed at the first outlet 17b of the second oil passage 17, a second needle valve 19b disposed at the second outlet 17c of the second oil passage 17, wherein the first and the second needle valves 19a, 19b are applied for adjusting oil output of the first outlet 17b and the second outlet 17c. Furthermore, operating smooth of automatic door closer can be improved via reciprocation of the piston 20 and action of the first and second oil passages 15, 17 according to the present invention.

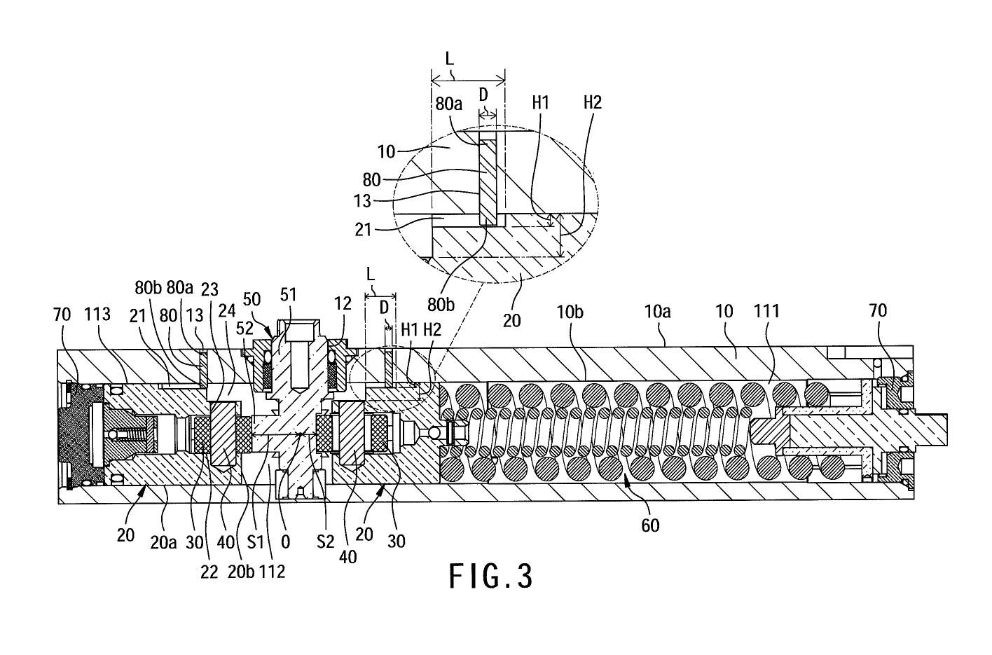

With reference to FIGS. 1, 2, and 3, the automatic door closer structure also uses a pair of pistons 20 slidably disposed inside the chamber 11 of the casing 10 and positioned at two laterals of the shaft hole 12 respectively. Each piston 20 has an outer wall 20a, an end surface 20b facing the shaft 50, a second limiting portion 21 formed on the outer wall 20a, a trench 22 recessed from the end surface 20b, a connecting hole 23 penetrating the trench 22 and a cavity 24 recessed from the outer wall 20a and communicating with the end surface 20b. Each second limiting portion 21 is a slot in communication with the end surface 20b and each second end portion 80b of the limiting member 80 is connected with each second limiting portion 21 of the piston 20, and preferably each second end portion 80b of the limiting member 80 projects into each second limiting portion (slot) 21 of the piston 20, so that the limiting members 80 can limit the pistons 20 not to rotate when the piston 20 are driven. Besides, each second limiting portion 21 has a length L and a first depth H1, and preferably each length L of the second limiting portions 21 is larger than each diameter D of the first limiting portions 13. With reference again to FIGS. 1 and 3, each second limiting portion 21 and each connecting hole 23 of the pistons 20 communicate with each cavity 24, because each second limiting portion 21 communicates with each cavity 21, it may prevent the pistons 20 from blocking of the limiting members 80 when assembled. Furthermore, each cavity 24 has a second depth H2 and preferably it is bigger than the first depth H1 of the second limiting portion 21 to further prevent the pistons 20 from blocking of the limiting member 80 when assembled.

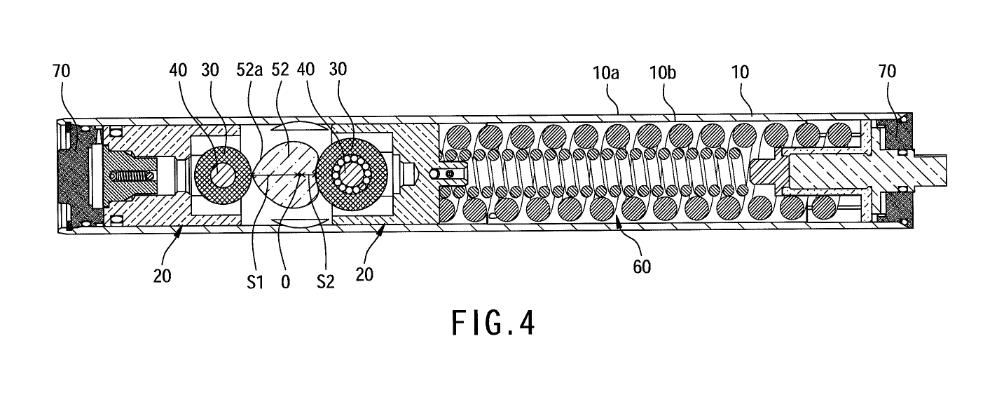

With reference again to FIGS. 1, 2 and 3, the automatic door closer structure further uses a pair of driving members 30 and a pair of connecting members 40, wherein the driving members 30 are rollers and connected with the pistons 20, preferably the driving members 30 are pivotally disposed at the trenches 22 of the pistons 20 respectively, each connecting member 40 is disposed by penetrating the connecting hole 23 of the piston 20 and the driving member 30. The shaft 50 comprises a shaft body 51 and an eccentric cam 52 coupled to the shaft body 51, wherein the shaft body 51 is pivotally disposed in the shaft hole 12 of the casing 10, the eccentric cam 52 can contact against the driving members 30 within this embodiment. Besides, with reference to FIGS. 3 and 4, the eccentric cam 52 has an axle center O and a cam edge 52a and there is a longest distance S1 and a shortest distance S2 between the axle center O and the cam edge 52a. It is preferable that the length L of each second limiting portion 21 is larger than a difference of between the longest distance S1 and the shortest distance S2 (i.e. L>S1−S2) to prevent the limiting members 80 from disengaging with the second limiting portions 21 when the pistons 20 transversely move. With reference again to FIGS. 1, 2 and 3, the elastic assembly 60 disposed within the chamber 11 of the casing 10 contacts against the piston 20 and may regulate opening/closing force with respect to the automatic door closer structure within this embodiment. Furthermore, the lids 70 seal two ends of the casing 10 respectively so as to prevent hydraulic oil from leaking.

The present invention can prevent the rotation of the piston 20 relative to the chamber 11 by applying engagement among the limiting member 80, the first limiting portion 13 of the casing 10 and the second limiting portion 21 of the piston 20, which efficiently reduces attrition among other components inside the door closer and enhances operating smooth of the door closer.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

1. An automatic door closer structure comprising:
a casing having a chamber and at least one first limiting portion;
at least one piston slidably disposed within the chamber of the casing and having an outer wall and a second limiting portion formed on the outer wall;
at least one limiting member connected with the first limiting portion and the second limiting portion to prevent the rotation of the piston relative to the chamber;
at least one driving member connected with the piston; and
a shaft comprising a shaft body pivotally disposed in the casing and an eccentric cam contacts against the driving member, wherein the second limiting portion of the piston has a length, the eccentric cam has an axle center and a cam edge, there are a longest distance and a shortest distance between the axle center and the cam edge, the length is larger than a difference between the longest distance and the shortest distance.

2. The automatic door closer structure in accordance with claim 1, wherein the limiting member has a first end portion and a second end portion, the first and second end portions are connected with the first limiting portion of the casing and the second limiting portion of the piston respectively.

3. The automatic door closer structure in accordance with claim 2, wherein the first end portion of the limiting member is fixed within the first limiting portion of the casing, the second end portion of the limiting member projects into the second limiting portion of the piston.

4. The automatic door closer structure in accordance with claim 3, wherein the casing has an outside wall and an inside wall, the first limiting portion of the casing is a through hole in communication with the outside wall and the inside wall, the second limiting portion of the piston is a slot, the first end portion of the limiting member is fixed within the through hole of the casing, the second end portion of the limiting member projects into the slot of the piston.

5. The automatic door closer structure in accordance with claim 1, wherein the casing has an outside wall and a shaft hole in communication with the outside wall and the chamber, the shaft body is pivotally disposed in the shaft hole, the first limiting portion is formed at one lateral of the shaft hole.

6. The automatic door closer structure in accordance with claim 1, wherein the first limiting portion of the casing has a diameter, the second limiting portion of the piston has a length larger than the diameter of the first limiting portion.

7. The automatic door closer structure in accordance with claim 1, further comprising a leak stopper disposed at the first limiting portion of the casing.

8. The automatic door closer structure in accordance with claim 1, wherein the piston has an end surface facing the shaft, the second limiting portion is a slot in communication with the end surface.

9. The automatic door closer structure in accordance with claim 8, wherein the piston has a cavity recessed from the outer wall, the cavity communicates with the end surface and the second limiting portion.

10. (canceled)

11. The automatic door closer structure in accordance with claim 1, wherein the casing further has a first oil passage and a second oil passage both are formed therein, the chamber has a front chamber, a rear chamber and a middle chamber in communication with the front chamber and the rear chamber, the first oil passage has an oil inlet in communication with the front chamber and an oil outlet in communication with the rear chamber, the second oil passage communicates with the rear chamber.

12. An automatic door closer structure comprising:
a casing having a chamber and at least one through hole;
at least one piston slidably disposed within the chamber of the casing and having an outer wall and a slot formed on the outer wall;
at least one limiting member connected with the through hole and the slot to prevent the rotation of the piston relative to the chamber;
at least one driving member connected with the piston; and
a shaft comprising a shaft body pivotally disposed in the casing and an eccentric cam contacts against the driving member, wherein the slot of the piston has a length, the eccentric cam has an axle center and a cam edge, there are a longest distance and a shortest distance between the axle center and the cam edge, the length is larger than a difference between the longest distance and the shortest distance

13. The automatic door closer structure in accordance with claim 12, wherein the limiting member has a first end portion and a second end portion, the first and second end portions are connected with the through hole of the casing and the slot of the piston respectively.

14. The automatic door closer structure in accordance with claim 13, wherein the first end portion of the limiting member is fixed within the through hole of the casing, the second end portion of the limiting member projects into the slot of the piston.

15. The automatic door closer structure in accordance with claim 12, wherein the casing has an outside wall and a shaft hole in communication with the outside wall and the chamber, the shaft body is pivotally disposed in the shaft hole, the through hole is formed at one lateral of the shaft hole.

16. The automatic door closer structure in accordance with claim 12, wherein the through hole of the casing has a diameter, the slot of the piston has a length larger than the diameter of the through hole.

17. The automatic door closer structure in accordance with claim 12, further comprising a leak stopper disposed at the through hole of the casing.

18. (canceled)

19. The automatic door closer structure in accordance with claim 12, wherein the casing further has a first oil passage and a second oil passage both are formed therein, the chamber has a front chamber, a rear chamber and a middle chamber in communication with the front chamber and the rear chamber, the first oil passage has an oil inlet in communication with the front chamber and an oil outlet in communication with the rear chamber, the second oil passage communicates with the rear chamber.
